(19) United States
(12) Patent Application Publication
(10) Pub. No.: US 2025/0264741 A1
(43) Pub. Date: Aug. 21, 2025

(54) SELF-ALIGNED METHOD FOR FORMING AN OPTICAL MODULATOR

(71) Applicant: Taiwan Semiconductor Manufacturing Co., Ltd., Hsinchu (TW)

(72) Inventors: Chia-Wei CHIANG, Hsinchu County (TW); Fan HU, Taipei City (TW); Sheng Kai YEH, Taichung City (TW); Chi-Yuan SHIH, Hsinchu (TW); Chun-Pei WU, Nantou County 551 (TW); Tse-En CHANG, Hsinchu City 300 (TW); Shih-Fen HUANG, Jhubei (TW)

(73) Assignee: Taiwan Semiconductor Manufacturing Co., Ltd., Hsinchu (TW)

(21) Appl. No.: 18/582,240

(22) Filed: Feb. 20, 2024

(51) Int. Cl. G02F 1/025; G02F 1/015

(52) U.S. Cl. CPC G02F 1/025; G02F 1/0151; G02F 2202/06

(57) ABSTRACT

The present disclosure is directed to a structure of an optical modulator and a method of forming the structure. The structure includes first, second, third, and fourth doped regions forming a C-shaped P-N junction in an optical waveguide. The method of forming the structure includes applying a first mask to form the first doped region by implanting dopants of a first type on a side surface of the optical waveguide. The method further includes applying a second mask to form the second, third, and fourth doped regions at different depths under a top surface of the optical waveguide by implanting dopants of the first type and a second type. The P-N junction formed by the method is self-aligned and immune to inline overlay and critical dimensions of the first and second masks, providing an improved profile of the P-N junction and a reliable and consistent product.

### BACKGROUND

The application of semiconductor photonics has revolutionized high-speed data communication systems, enabling the transmission of data over long distances via optical waveguides with low power consumption. Data in the form of optical signals can be modulated by optical modulators, which are key components in semiconductor photonics and can be formed within optical waveguides as P-N junctions. An important specification of optical modulators is an optical modulation amplitude (OMA) of the optical signals and is determined by the structural and doping profiles of the P-N junctions.

### BRIEF DESCRIPTION OF THE DRAWINGS

Aspects of the present disclosure are best understood from the following detailed description when read with the accompanying figures.

FIG. 1A is a cross-sectional view of an optical modulator, in accordance with some embodiments.

FIG. 1B is a top view of an optical modulator, in accordance with some embodiments.

FIG. 1C is a cross-sectional view of an optical modulator, in accordance with some embodiments.

FIG. 2 is a flowchart of a fabrication method for the formation of an optical modulator, in accordance with some embodiments.

FIGS. 3 through 14 are cross-sectional views of intermediate structures during the fabrication of an optical modulator, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over a second feature in the description that follows may include embodiments in which the first and second features are formed in direct contact, and may also include embodiments in which additional features may be formed that are between the first and second features such that the first and second features are not in direct contact.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some embodiments, the terms “about” and “substantially” can indicate a value of a given quantity that varies within 5% of the value (c.g., ±1%, ±2%, ±3%, ±4%, ±5% of the value). These values are merely examples and are not intended to be limiting. It is to be understood that the terms “about” and “substantially” can refer to a percentage of the values as interpreted by those skilled in relevant art(s) in light of the teachings herein.

In semiconductor photonics devices, optical modulators are components used for modulating optical signals propagating in optical waveguides. An optical modulator disposed in a section of an optical waveguide can include a P-N junction controlled by an external bias voltage. Under different bias conditions (e.g., forward bias or reverse bias) determined by the external bias voltage, the P-N junction can adjust a charge carrier density, hence an optical parameter (c.g., a refractive index) of the optical modulator such that an optical signal propagating in the optical waveguide can be modulated. A modulation efficiency of the optical modulator can be affected by a profile of the P-N junction, such as its shape and/or doping profile. For example, within a geometry of the optical waveguide, a C-shaped P-N junction with a larger junction area can be beneficial to a higher modulation efficiency, in comparison to a planar P-N junction.

The C-shaped P-N junction in the optical waveguide can include first, second, and third doped regions with dopants of a first type (e.g., n-type), together with a fourth doped region with dopants of a second type (c.g., p-type) opposite to the first type. The second and third doped regions can be connected by the first doped region, while the fourth doped region can be partially enclosed by the first, second, and third doped regions, forming a C-shaped interface between doped regions of opposite types. Fabrication processes of forming the C-shaped P-N junction can undergo three lithography/ion implantation processes and require three masks (c.g., photoresist). The lithography/ion implantation processes include a sidewall n-type implantation, an upper n-type/middle p-type implantation, and a bottom n-type implantation.

In some of the lithography/ion implantation processes, boundaries of the mask need to be accurately disposed within small ranges on the optical waveguide, which poses a challenging lithography operation especially when a design window is limited by a small width of the optical waveguide. In addition, a variation of an inline overlay and/or critical dimension of the mask can significantly affect profile of the P-N junction, compromising the performance of the semiconductor photonics devices and impacting product yield.

To overcome the challenges mentioned above, the embodiments described herein are directed to a semiconductor device including an optical modulator and a method of forming the semiconductor device. In some embodiments, the optical modulator can include a first doped region under a side surface of an optical waveguide, a second doped region under a top surface of the optical waveguide, a third doped region under the second doped region, and a fourth region between the second and third doped regions. In some embodiments, the first, second, and third doped regions can include dopants of a first type (e.g., n-type), and the fourth doped region can include dopants of a second type (c.g., p-type) opposite to the first type. In some embodiments, the first, second, third, and fourth doped regions can form a P-N junction having a ‘C’ shape in the optical modulator. In some embodiments, the method of forming the semiconductor device can apply two masks to define the doped regions of the optical modulator. In some embodiments, a first mask can be applied to form the first doped region by implanting dopants of the first type under the side surface of the optical waveguide. In some embodiments, a second mask with boundaries outside a width of the optical waveguide can be applied to form the second, third, and fourth doped regions by implanting dopants of the first and second types under the top surface of the optical waveguide. In some embodiments, the method can provide a robust design window and can improve a product yield. In some embodiments, the doped regions in the optical modulator formed by the method can be self-aligned and immune to variations of the first and second masks, resulting in improved reliability and consistency of the optical modulator. In some embodiments, the P-N junction formed by the method can have greater overlap with optical modes in the optical waveguide, providing enhanced modulation efficiency than those formed by other fabrication processes.

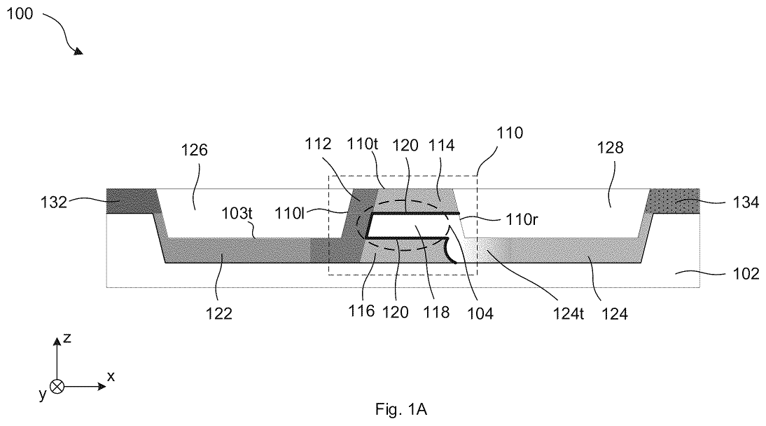

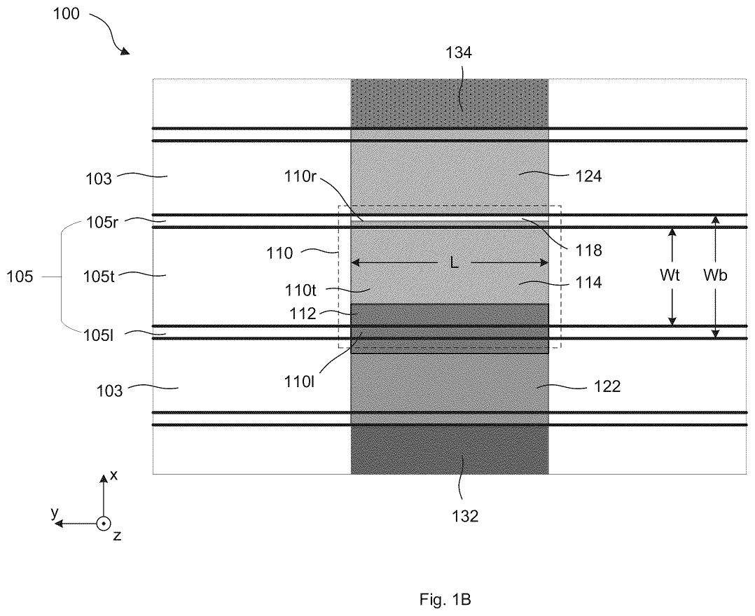

A semiconductor device 100 having a P-N junction 120 formed over a substrate 102 is described with reference to FIGS. 1A-1C, according to some embodiments. FIG. 1A illustrates a cross-sectional view of semiconductor device 100, according to some embodiments. FIG. 1B illustrates a top view of semiconductor device 100, according to some embodiments. FIG. 1C illustrates a zoomed-in, cross-sectional view of semiconductor device 100, according to some embodiments.

Referring to FIG. 1A, substrate 102 can be a semiconductor material, such as silicon (Si). In some embodiments, substrate 102 can include a crystalline silicon substrate (e.g., Si wafer). In some embodiments, substrate 102 can include (i) an elementary semiconductor, such as silicon or germanium (Ge); (ii) a compound semiconductor including silicon carbide (SiC), gallium arsenide (GaAs), gallium phosphide (GaP), indium phosphide (InP), indium arsenide (InAs), and/or indium antimonide (InSb); (iii) an alloy semiconductor including silicon germanium carbide (SiGeC), silicon germanium (SiGe), gallium arsenic phosphide (GaAsP), gallium indium phosphide (InGaP), gallium indium arsenide (InGaAs), gallium indium arsenic phosphide (InGaAsP), aluminum indium arsenide (InAlAs), and/or aluminum gallium arsenide (AlGaAs); or (iv) a combination thereof. Further, substrate 102 can be doped depending on design requirements (e.g., p-type substrate or n-type substrate). In some embodiments, substrate 102 can be undoped. In some embodiments, substrate 102 can be doped with p-type dopants (e.g., boron (B), indium (In), aluminum (Al), or gallium (Ga)) or n-type dopants (e.g., phosphorus (P), arsenic (As), or antimony (Sb)). In some embodiments, a crystal orientation of substrate 102 can be (100), (110), or (111).

Referring to FIG. 1B, semiconductor device 100 can include an optical waveguide 105 disposed on substrate 102. For example, as shown in FIG. 1B, optical waveguide 105 can include a ridge structure extending along a horizontal direction (c.g., along the y-axis) and protruding out of substrate 102 along a vertical direction (e.g., along the z-direction). In some embodiments, the ridge structure can be disposed between trench structures 103. Waveguide 105 can have a top surface 105t and first and second side surfaces 105l and 105r. In some embodiments, optical waveguide 105 can include the same material as substrate 102. In some embodiments, optical waveguide 105 can include Si. In some embodiments, optical waveguide 105 can have the same doping profile as substrate 102. In some embodiments, optical waveguide 105 can be undoped or lightly doped.

Referring to FIGS. 1A-1C, in some embodiments, semiconductor device 100 can include an optical modulator 110 formed in a section of optical waveguide 105 by selectively doping different portions of the section of optical waveguide 105 with different dopants to form P-N junction 120. In some embodiments, optical modulator 110 can have a same shape of a cross section as optical waveguide 105, as shown in FIG. 1B. In particular, optical modulator 110 can have a top surface 110t substantially coplanar with top surface 105t of optical waveguide 105. Optical modulator 110 can also have first and second side surfaces 110l and 110r substantially coplanar with first and second side surfaces 105l and 105r of optical waveguide 105, respectively. In some embodiments, side surfaces 110l, 110r, 105l, and 105r can connect with bottom surfaces 103t of trench structures 103. The ridge structure of optical waveguide 105 and optical modulator 110 can have a cross section in a trapezoidal shape. For example, as shown in FIGS. 1A and 1C, an angle θl between side surface 110l and bottom surface 103t can be between about 60° and about 120°, and an angle θr between side surface 110r and bottom surface 103t can be between about 60° and about 120°. In some embodiments, the cross section of the ridge structure can be rectangular. For example, angles θl and θr can both be about 90°. In some embodiments, the cross section of the ridge structure can also be other shapes, such as a triangle, a parallelogram, a polygon, or an irregular shape. In some embodiments, different sections of the ridge structure can have cross sections of different sizes/shapes. In some embodiments, as shown in FIG. 1B, a length L of optical modulator 110 can be between about 200 nm and about 1000 nm. In some embodiments, as shown in FIGS. 1B and 1C, a width Wt of top surfaces 105t and 110t can be between about 200 nm and about 500 nm. In some embodiments, a distance Wb between bottom edges of side surfaces 110l and 110r can be between about 200 nm and about 600 nm. In some embodiments, optical waveguide 105 and optical modulator 110 can also include a portion of substrate 102 directly under the ridge structure. In some embodiments, as shown in FIG. 1C, a height H of optical modulator 110 can be between about 160 nm and about 300 nm. In some embodiments, as shown in FIG. 1A, an optical signal 104 can propagate in optical waveguide 105 and can be modulated by optical modulator 110 when P-N junction 120 is under different bias conditions.

In some embodiments, optical modulator 110 can include a first doped region 112, a second doped region 114, a third doped region 116, and a fourth doped region 118, as shown in FIGS. 1A and 1B. In some embodiments, first doped region 112 can be directly under side surface 110l. In some embodiments, first doped region 112 can include a portion below the ridge structure and in the substrate. In some embodiments, top surface 110t can include a top surface 112t of first doped region 112, as shown in FIG. 1C. In some embodiments, a width W4 of top surface 112t can be between about 50 nm and about 100 nm. In some embodiments, bottom surface 103t can include an upper surface of the portion of first doped region 112 below the ridge structure and in the substrate. In some embodiments, first doped region 112 can be doped with dopants of a first type. For example, first doped region 112 can be doped with n-type dopants, such as P, As, Sb, and/or a combination thereof. In some embodiments, a doping concentration of first doped region 112 can be between about 1×10¹⁸ cm⁻³ and about 2×10²⁰ cm⁻³.

In some embodiments, second doped region 114 can disposed directly under top surface 110t and adjacent to first doped region 112, as shown in FIGS. 1A and 1C. In some embodiments, side surface 110r can include a side surface of second doped region 114. In some embodiments, second doped region 114 can be in contact with first doped region 112. In some embodiments, an interface between first doped region 112 and second doped region 114 can be substantially parallel to side surface 110l. In some embodiments, a thickness T1 of second doped region 114 can be between about 50 nm and about 100 nm. In some embodiments, second doped region 114 can be doped with dopants of the first type. For example, second doped region 114 can be doped with n-type dopants, such as P, As, Sb, and/or a combination thereof. In some embodiments, a doping concentration of second doped region 114 can be between about 2×10¹⁸ cm⁻³ and about 1×10²⁰ cm⁻³.

In some embodiments, fourth doped region 118 can be disposed directly under second doped region 114 and adjacent to first doped region 112, as shown in FIG. 1A and 1C. In some embodiments, fourth doped region 118 can be in contact with second doped region 114. In some embodiments, an interface 120u between second doped region 114 and fourth doped region 118 can be substantially parallel to top surface 110t. In some embodiments, fourth doped region 118 can be in contact with first doped region 112. In some embodiments, an interface 120l between first doped region 112 and fourth doped region 118 can be substantially parallel to side surface 110l. In some embodiments, interface 120l can be curved. In some embodiments, side surface 110r can include a side surface of fourth doped region 118. In some embodiments, a thickness T2 of fourth doped region 118 can be between about 50 nm and about 100 nm. In some embodiments, fourth doped region 118 can be doped with dopants of a second type opposite to the first type. For example, fourth doped region 118 can be doped with p-type dopants, such as B, Al, Ga, In, and/or a combination thereof. In some embodiments, a doping concentration of fourth doped region 118 can be between about 2×10¹⁸ cm⁻³ and about 1×10²⁰ cm⁻³.

In some embodiments, third doped region 116 can be disposed directly under fourth doped region 118 and adjacent to first doped region 112, as shown in FIG. 1A and 1C. In some embodiments, third doped region 116 can be in contact with fourth doped region 118. In some embodiments, an interface 120b between third doped region 116 and fourth doped region 118 can be substantially parallel to interface 120u. In some embodiments, interface 120b can be substantially coplanar with bottom surface 103t. In some embodiments, interface 120b can be above or below bottom surface 103t. In some embodiments, third doped region 116 can be in contact with first doped region 112. In some embodiments, an interface between first doped region 112 and third doped region 116 can be substantially coplanar with interface 120l. In some embodiments, a thickness T3 of third doped region 116 can be between about 50 nm and about 100 nm. In some embodiments, third doped region 116 can be doped with dopants of the first type. For example, third doped region 116 can be doped with n-type dopants, such as P, As, Sb, and/or a combination thereof. In some embodiments, a doping concentration of third doped region 116 can be between about 2×10¹⁸ cm⁻³ and about 1×10²⁰ cm⁻³.

In some embodiments, first, second, and third doped regions 112, 114, and 116 with the same type of dopants can form a ‘C’ shape. In some embodiments, despite of being the same type, dopants in first doped region 112, second doped region 114, and third doped region 116 can be the same or different. For example, dopants in first doped region 112 can include P and As, while dopants in second doped region 114 and third doped region 116 can include only P. In some embodiments, since the second type of dopants in fourth doped region 118 is opposite to dopants of the first type in first, second, and third regions 112, 114, and 116, P-N junction 120 can be formed at interfaces 120l, 120u, and 120b, as shown in FIGS. 1A and 1C. In some embodiments, a width W1 of interface 120u and a width W2 of interface 120b can be between about 150 nm and about 500 nm.

In some embodiments, first doped region 112 can further include first, second, and third portions 112a, 112b, and 112c, as shown in FIG. 1C. First, second, and third portions 112a, 112b, and 112c can have different doping profiles. In some embodiments, dopants in first portion 112a and third portion 112c can be of the first type. For example, first portion 112a and third portion 112c can be can be n-type doped. In some embodiments, second portion 112b can include dopants of both the first and second types. For example, second portion 112b can be doped with both n-type and p-type dopants, with a concentration of the n-type dopants greater than that of the p-type dopants such that second portion 112b can overall have an n-type concentration. In some embodiments, the concentration of dopants of the second type in second portion 112b can be substantially the same as the concentration of dopants in fourth doped region 118. In some embodiments, a difference between a concentration of the first type dopants in first portion 112a and the concentration of the first type dopants in second portion 112b can be substantially equal to the concentration of the first type dopants in second doped region 114. In some embodiments, a difference between a concentration of the first type dopants in third portion 112c and the concentration of the first type dopants in second portion 112b can be substantially equal to the concentration of the first type dopants in third doped region 116.

Referring to FIG. 1C, in some embodiments, first portion 112a can have the same thickness T1 as second doped region 114. In some embodiments, an interface between first portion 112a and second portion 112b can connect with and substantially be coplanar with interface 120u. In some embodiments, second portion 112b can have the same thickness T2 as fourth doped region 118. In some embodiments, an interface between third portion 112c and second portion 112b can connect with and substantially be coplanar with interface 120b. In some embodiments, the interface between third portion 112c and second portion 112b can connect with and substantially be coplanar with bottom surface 103t. In some embodiments, third portion 112c can have the same thickness T3 as third doped region 116.

Referring to FIG. 1A, in some embodiments, semiconductor device 100 can include a first contact region 132 electrically connected with first doped region 112 by a first pick-up region 122. In some embodiments, first pick-up region 122 and first contact region 132 can be portions of substrate 102 and can include dopants of the first type, which is the same type as dopants in first doped region 112. For example, first pick-up region 122 and first contact region 132 can include n-type dopants, such as P, As, Sb, or a combination thereof. In some embodiments, a doping concentration of first pick-up region 122 can be between about 5×10¹⁸ cm⁻³ and about 1×10²¹ cm⁻³. In some embodiments, the doping concentration of first pick-up region 122 can be greater than the doping concentration of first doped region 112. In some embodiments, a doping concentration of first contact region 132 can be between about 5×10¹⁸ cm⁻³ and about 1×10²¹ cm⁻³. In some embodiments, as shown in FIG. 1C, a thickness T5 of first pick-up region 122 can be between about 30 nm and about 200 nm. In some embodiments, a thickness of first contact region 132 can be between about 30 nm and about 200 nm. In some embodiments, a top surface of first contact region 132 can be substantially coplanar with top surface 110t.

In some embodiments, semiconductor device 100 can include a second contact region 134 electrically connected with fourth doped region 118 by a second pick-up region 124. In some embodiments, second pick-up region 124 and second contact region 134 can be portions of substrate 102 and can include dopants of the second type, which is the same type as dopants in fourth doped region 118. For example, second pick-up region 124 and second contact region 134 can include p-type dopants, such as B, Al, As, In, or a combination thereof. In some embodiments, a doping concentration of second pick-up region 124 can be between about 5×10¹⁸ cm⁻³ and about 1×10²¹ cm⁻³. In some embodiments, the doping concentration of second pick-up region 124 can be greater than the doping concentration of fourth doped region 118. In some embodiments, a doping concentration of second contact region 134 can be between about 5×10¹⁸ cm⁻³ and about 1×10²¹ cm⁻³. In some embodiments, as shown in FIG. 1C, a thickness T6 of second pick-up region 124 can be between about 30 nm and about 200 nm. In some embodiments, a thickness of second contact region 134 can be between about 30 nm and about 200 nm. In some embodiments, a top surface of second contact region 134 can be substantially coplanar with top surface 110t.

In some embodiments, as shown in FIGS. 1A and 1C, second pick-up region 124 can include a compensated region 124t in contact with third doped region 116 and fourth doped region 118. In some embodiments, in addition to dopants of the second type, compensated region 124t can also include dopants of the first type, the same as those in third doped region 116. In some embodiments, compensated region 124t can have a doping profile with a first concentration of dopants of the first type gradually increase towards third doped region 116 and with a second concentration of dopants of the second type gradually decrease towards third doped region 116. In some embodiments, an interface 120r between compensated region 124t and third doped region 116 can be a P-N junction, which can be a part of P-N junction 120. In some embodiments, interface 120r can be curved.

Referring to FIGS. 1A and 1B, in some embodiments, semiconductor device 100 can further include dielectric layers 126 and 128 disposed in trench structures 103. In some embodiments, dielectric layers 126 and 128 can be disposed over first and second pick-up regions 122 and 124, respectively. In some embodiments, top surfaces of dielectric layers 126 and 128 can be substantially coplanar with top surface 110t.

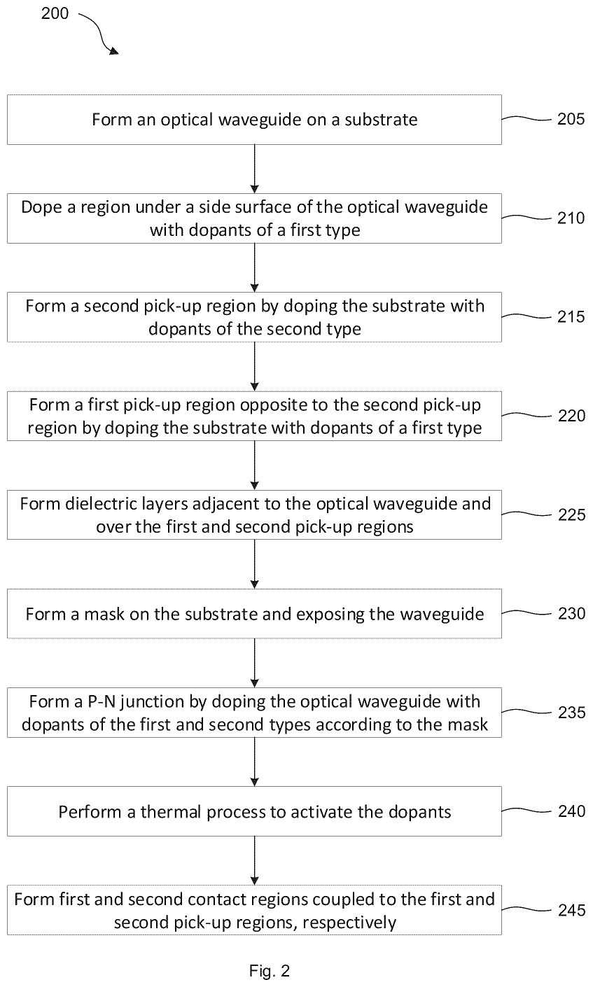

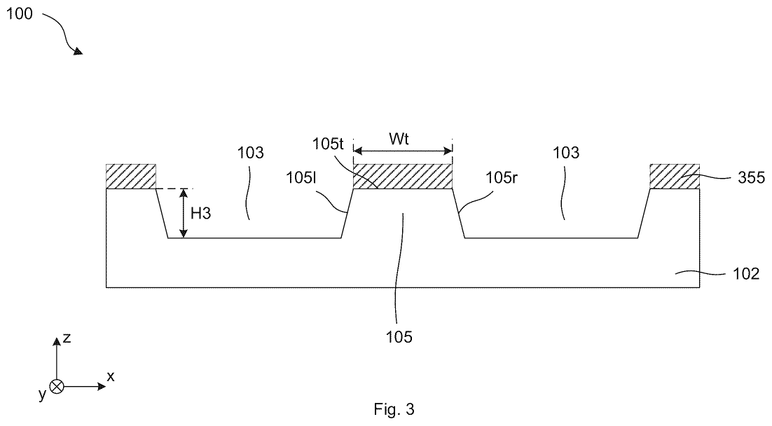

According to some embodiments, FIG. 2 illustrates a flowchart of a method 200 for forming optical modulator 110 in semiconductor device 100 as shown in FIGS. 1A-1C. This disclosure is not limited to this operational description and additional operations may be performed. Other fabrication operations can be performed between the various operations of method 200 and are omitted merely for clarity. Moreover, not all operations may be needed to perform the disclosure provided herein. Additionally, some of the operations may be performed simultaneously, or in a different order than the ones shown in FIG. 2. In some embodiments, one or more other operations may be performed in addition to or in place of the presently described operations. For illustrative purposes, method 200 is described with reference to the structures shown in FIGS. 3-14. The discussion of elements in FIGS. 1A-1C with the same annotations applies to FIGS. 3-14, unless mentioned otherwise.

Referring to FIG. 2, method 200 begins with operation 205 and the process of forming an optical waveguide on a substrate (e.g., substrate 102), as described with reference to FIG. 3. FIG. 3 is a cross-sectional view of semiconductor device 100 after operation 205 and the formation of optical waveguide 105 having top surface 105t and first and second side surfaces 105l and 105r. In some embodiments, forming optical waveguide 105 can include patterning substrate 102 with a hard mask 355 and removing portions of substrate 102 uncovered by hard mask 355 to form trench structures 103 with a depth H3. In some embodiments, hard mask 355 can be a shallow trench isolation (STI) layer. In some embodiments, hard mask 355 can be patterned to include a strip shape extending in a horizontal direction (c.g., the x direction) and having width Wt that determines the width of top surface 105t of optical waveguide 105. In some embodiments, trench structures 103 can be formed by wet etch, dry etch, or a combination thereof. In some embodiments, trench structures 103 can be formed by etching substrate 102 anisotropically such that side surfaces 105l and 105r can be slanted or substantially perpendicular to substrate 102.

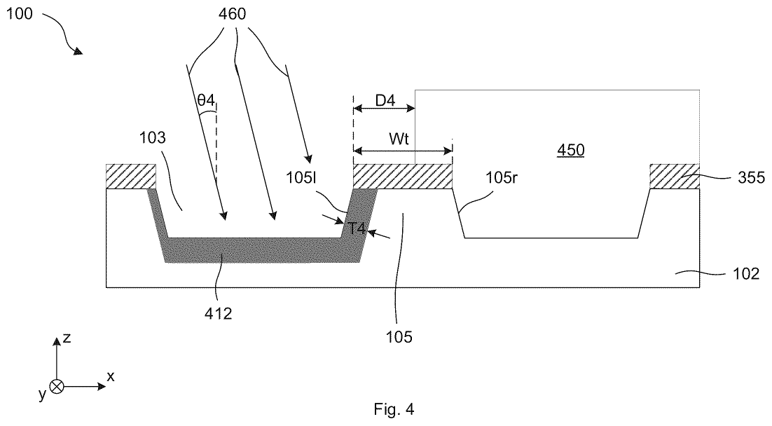

In referring to FIG. 2, method 200 continues with operation 210 and the process of doping a region under a side surface of the optical waveguide with dopants of a first type (c.g., n-type), as described with reference to FIG. 4. FIG. 4 is a cross-sectional view of semiconductor device 100 in operation 210 during the formation of a doped region 412. In some embodiments, forming doped region 412 can include (i) covering side surface 105r of optical waveguide 105 with a photoresist 450 while exposing side surface 105l of optical waveguide 105 and (ii) doping a region of waveguide 105 under side surface 105l by implanting dopants 460 in an ion implantation process. In some embodiments, covering side surface 105r of optical waveguide 105 can include covering a trench structure 103 on a same side of optical waveguide 105 as side surface 105r. In some embodiments, covering side surface 105r of optical waveguide 105 can include covering a first portion of a top surface of hard mask 355 closer to side surface 105r while exposing a second portion of the top surface of hard mask 355 closer to side surface 105l. In some embodiments, a width D4 of the exposed second portion of the top surface of hard mask 355 can be between about zero and about width Wt such that a boundary of photoresist 450 can be formed within a margin as great as width Wt. Hard mask 355 can serve as a self-aligned mask such that doped region 412 can be robustly formed, despite a varying alignment of photoresist 450 within this margin. In some embodiments, exposing side surface 105l of optical waveguide 105 can include exposing a trench structure 103 on a same side of optical waveguide 105 as side surface 105l. In some embodiments, implanting dopants 460 can include forming doped region 412 having a thickness T4 (between about 40 nm and about 100 nm) into side surface 105l of optical waveguide 105 by choosing proper ion implantation parameters. In some embodiments, implanting dopants 460 can include implanting P and/or As to form doped region 412. In some embodiments, implanting dopants 460 can include implanting P at an energy between about 40 keV and about 80 keV. In some embodiments, implanting dopants 460 can include implanting P at a dose between about 1×10¹⁴ cm⁻² and about 6×10¹⁴ cm⁻². In some embodiments, implanting dopants 460 can include implanting As at an energy between about 20 keV and about 60 keV. In some embodiments, implanting dopants 460 can include implanting As at a dose between about 5×10¹³ cm⁻² and about 5×10¹⁴ cm⁻². In some embodiments, implanting dopants 460 can include implanting P and/or As at an angle θ4 between about 0° and about 45° with respect to the vertical direction (e.g., along the z-direction). In some embodiments, operation 210 can further include removing photoresist 450 after the formation of doped region 412.

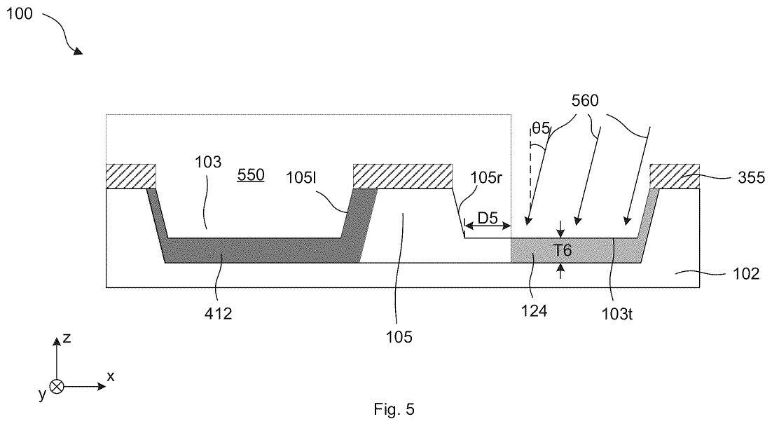

Method 200 continues with operation 215 and the process of forming a pick-up region by doping the substrate with dopants of the second type (e.g., p-type) opposite to the first type, as described with reference to FIG. 5. FIG. 5 is a cross-sectional view of semiconductor device 100 in operation 215 during the formation of second pick-up region 524. In some embodiments, forming second pick-up region 524 can include (i) covering optical waveguide 105 with a photoresist 550 while exposing a portion of trench structure 103 on the same side of optical waveguide 105 as side surface 105r and (ii) doping a region of the exposed portion of trench structure 103 by implanting dopants 560 in an ion implantation process. In some embodiments, covering optical waveguide 105 can include covering side surface 105l together with the region on the same side of optical waveguide 105 as side surface 105l. In some embodiments, covering optical waveguide 105 can include covering side surface 105r together with a portion of trench structure 103 adjacent to side surface 105r. In some embodiments, a horizontal distance D5 between a boundary of photoresist 550 and optical waveguide 105 can be between about 100 nm and about 800 nm. In some embodiments, implanting dopants 560 can include forming second pick-up region 524 having a thickness T6 into bottom surface 103t of trench structure 103 by choosing proper ion implantation parameters. In some embodiments, implanting dopants 560 can include implanting B at an energy between about 10 keV and about 30 keV. In some embodiments, implanting dopants 560 can include implanting B at a dose between about 1×10¹⁴ cm⁻² and about 3×10¹⁵ cm⁻². In some embodiments, implanting dopants 560 can include implanting B at an angle θ5 between about 0° and about 30° with respect to the vertical direction (e.g., along the z-direction). In some embodiments, operation 215 can further include removing photoresist 550 after the formation of second pick-up region 524.

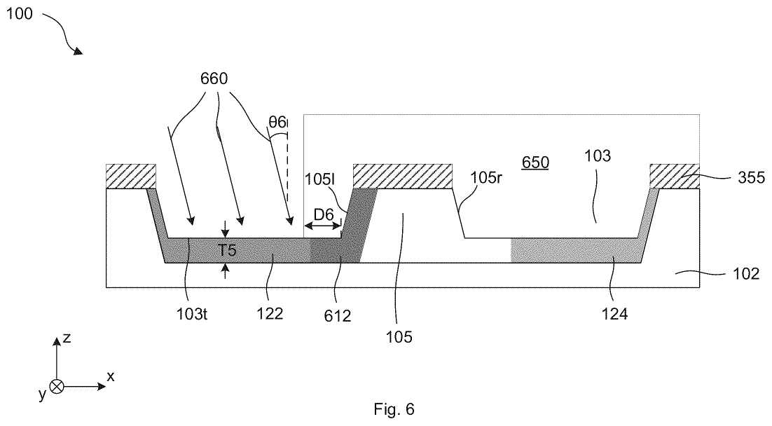

Method 200 continues with operation 220 and the process of forming another pick-up region on an opposite side of the optical waveguide with respect to the pick-up region, by doping the substrate with dopants of the first type (e.g., n-type), as described with reference to FIG. 6. FIG. 6 is a cross-sectional view of semiconductor device 100 after operation 220 and the formation of first pick-up region 122. In some embodiments, forming first pick-up region 122 can include (i) covering optical waveguide 105 with a photoresist 650 while exposing a portion of trench structure 103 on the same side of optical waveguide 105 as side surface 105l and (ii) doping a region of the exposed portion of trench structure 103 by implanting dopants 660 in an ion implantation process. In some embodiments, covering optical waveguide 105 can include covering side surface 105r together with the region on the same side of optical waveguide 105 as side surface 105r. In some embodiments, covering optical waveguide 105 can include covering side surface 105l together with a portion of trench structure 103 adjacent to side surface 105l. In some embodiments, a horizontal distance D6 between a boundary of photoresist 650 and optical waveguide 105 can be between about 100 nm and about 800 nm. In some embodiments, implanting dopants 660 can include forming first pick-up region 122 having thickness T5 into bottom surface 103t of trench structure 103 by choosing proper ion implantation parameters. In some embodiments, implanting dopants 660 can include implanting P at an energy between about 10 keV and about 30 keV. In some embodiments, implanting dopants 660 can include implanting P at a dose between about 1×10¹⁴ cm⁻² and about 3×10¹⁵ cm⁻². In some embodiments, implanting dopants 660 can include implanting P at an angle θ6 between about 0° and about 30° with respect to the vertical direction (e.g., along the z-direction). In some embodiments, first pick-up region 122 can overlap with a portion of doped region 412, and turning the remaining portion of doped region 412 into a doped region 612. Since being doped twice (by implanting dopants 460 and dopants 660), first pick-up region 122 can have a doping concentration greater than doped region 612. In some embodiments, operation 220 can further include removing photoresist 650 and hard mask 355 after the formation of first pick-up region 122.

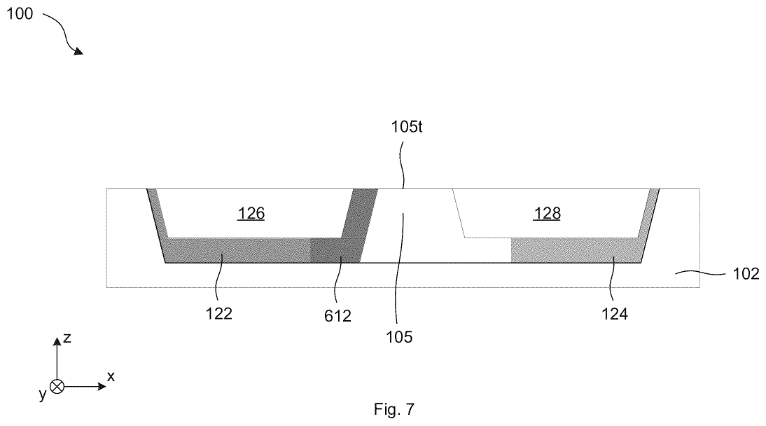

In referring to FIG. 2, method 200 continues with operation 225 and the process of forming dielectric layers adjacent to the optical waveguide and over the pick-up regions, as described with reference to FIG. 7. FIG. 7 is a cross-sectional view of semiconductor device 100 after operation 225 and the formation of dielectric layers 126 and 128. The process of forming dielectric layers 126 and 128 can include (i) blanket depositing a layer of dielectric material over optical waveguide 105 and trench structures 103 and (ii) planarizing the layer of dielectric material to expose top surface 105t of optical waveguide 105. In some embodiments, the layer of dielectric material can be deposited by a chemical vapor deposition (CVD) process, a physical vapor deposition (PVD) process, an atomic layer deposition (ALD) process, or a combination thereof. In some embodiments, planarizing the layer of dielectric material can include performing a chemical mechanical polishing (CMP) process to thin the layer of dielectric material until top surfaces of dielectric layers 126 and 128 are substantially coplanar with top surface 105t.

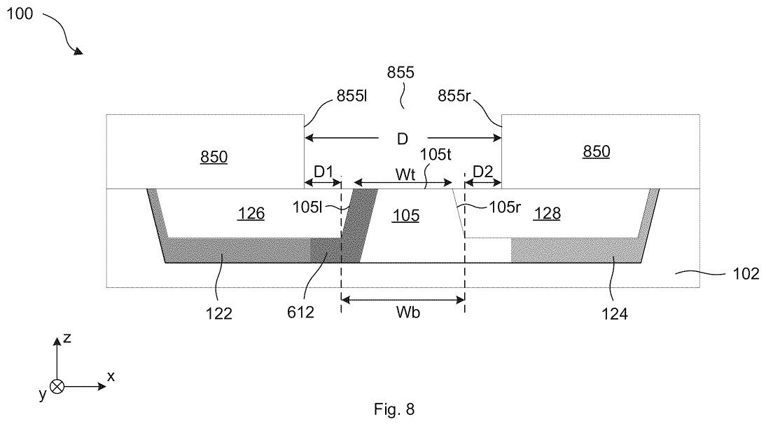

In referring to FIG. 2, method 200 continues with operation 230 and the process of forming a mask on the substrate and exposing the optical waveguide, as described with reference to FIG. 8. FIG. 8 is a cross-sectional view of semiconductor device 100 after operation 230 and the formation of a mask 850. In some embodiments, mask 850 can be a photoresist mask and can serve as a self-aligned mask for subsequent operations of ion implantation. In some embodiments, mask 850 can expose top surface 105t of optical waveguide 105 by an opening 855 having a width D greater than width Wb of optical waveguide 105. In some embodiments, opening 855 can expose top surface 105t over an entire range of its width Wt. In some embodiments, a first boundary 855l of opening 855 can be on dielectric layer 126, and a horizontal distance DI between first boundary 855l and optical waveguide 105 can be about 0 nm and about 1000 nm. In some embodiments, a second boundary 855r of opening 855 can be on dielectric layer 128, and a horizontal distance D2 between second boundary 855r and optical waveguide 105 can be about 0 nm and about 1000 nm. In some embodiments, width D of opening 855 can provide a margin between about 0 nm and about 2000 nm for an alignment of mask 850 with respect to optical waveguide 105, such that subsequent operations of ion implantation can be performed robustly despite a variation of the alignment of mask 850 within this margin. Mask 850 and photoresist 450, as described with reference to FIG. 4, are the only two masks applied in method 200 to define the doping profile of optical modulator 110 as shown in FIG. 1A-1C, according to some embodiments.

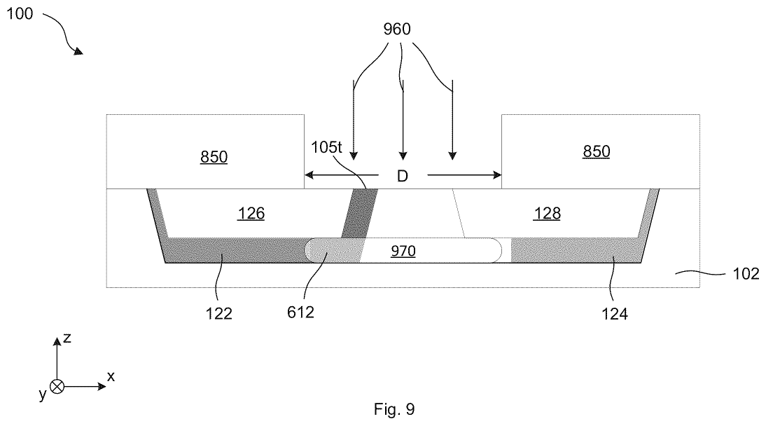

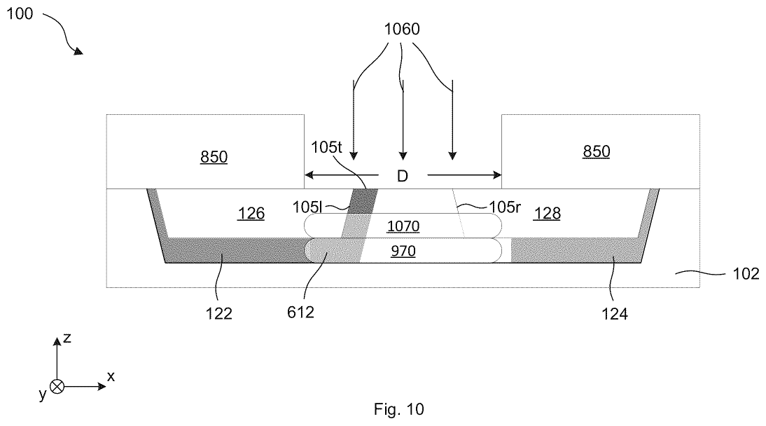

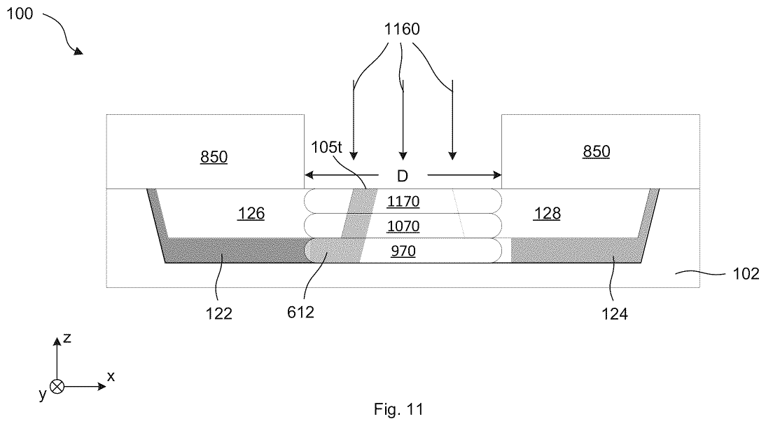

In referring to FIG. 2, method 200 continues with operation 235 and the process of forming a P-N junction by doping the optical waveguide with dopants of the first and second types using the mask, as described with reference to FIGS. 9-11. FIGS. 9-11 are cross-sectional views of semiconductor device 100 during operation 235. In some embodiments, operation 235 can include (i) forming a region 970 in optical waveguide 105 and substrate 102 by implanting dopants 960 of the first type (e.g., n-type) in a first ion implantation process, as described with reference to FIG. 9, (ii) forming a region 1070 in optical waveguide 105 and dielectric layers 126 and 128 by implanting dopants 1060 of the second type (e.g., p-type) in a second ion implantation process, as described with reference to FIG. 10, and (iii) forming a region 1170 in optical waveguide 105 and dielectric layers 126 and 128 by implanting dopants 1160 of the first type (c.g., n-type) in a third ion implantation process, as described with reference to FIG. 11. Regions 970, 1070, and 1170 have different depths with respect to top surface 105t. Region 970 is the deepest, region 1170 is the shallowest, and region 1070 is between region 970 and region 1170. In some embodiments, regions 970, 1070, and 1170 can have widths substantially the same as width D based on the same mask 850.

In some embodiments, forming region 970 can be formed at a bottom portion of optical waveguide 105 at a depth similar to first and second pick-up regions 122 and 124, by choosing proper ion implantation parameters. In some embodiments, forming region 970 can include implanting P at an energy between about 100 keV and about 200 keV. In some embodiments, forming region 970 can include implanting P at a dose between about 5×10¹³ cm⁻² and about 5×10¹⁴ cm⁻². In some embodiments, forming region 970 can include implanting P at an angle about 0°. In some embodiments, region 970 can overlap with a lowest portion of doped region 612. In some embodiments, region 970 can overlap with a portion of first pick-up region 122 adjacent to doped region 612. In some embodiments, region 970 can overlap with a portion of second pick-up region 124. In some embodiments, region 970 can be separated from second pick-up region 124.

In some embodiments, forming region 1070 can include doping region 1070 at a depth around a middle portion of optical waveguide 105 by choosing proper ion implantation parameters. In some embodiments, forming region 1070 can include implanting B at an energy between about 20 keV and about 60 keV. In some embodiments, forming region 1070 can include implanting B at a dose between about 5×10¹³ cm⁻² and about 5×10¹⁴ cm⁻². In some embodiments, forming region 1070 can include implanting B at an angle about 0°. In some embodiments, region 1070 can overlap with a middle portion of doped region 612. In some embodiments, due to the exposure of mask 850, region 1070 can overlap with a lower portion of dielectric layer 126 adjacent to side surface 105l. In some embodiments, due to the exposure of mask 850, region 1070 can overlap with a lower portion of dielectric layer 128 adjacent to side surface 105r. In some embodiments, the lower portion of dielectric layer 126 and/or the lower portion of dielectric layer 128 can include the implanted dopants of the second type. In some embodiments, concentrations of dopants of the second type in the lower portion of dielectric layer 126 and the lower portion of dielectric layer 128 can be substantially the same.

In some embodiments, forming region 1170 can include doping region 1170 at a depth around an upper portion of optical waveguide 105 by choosing proper ion implantation parameters. In some embodiments, forming region 1170 can include implanting P at an energy between about 20 keV and about 50 keV. In some embodiments, forming region 1170 can include implanting P at a dose between about 5×10¹³ cm⁻² and about 5×10¹⁴ cm⁻². In some embodiments, forming region 1170 can include implanting P at an angle about 0°. In some embodiments, region 1170 can overlap with a top portion of doped region 612. In some embodiments, due to the exposure of mask 850, region 1170 can overlap with an upper portion of dielectric layer 126 adjacent to side surface 105l. In some embodiments, due to the exposure of mask 850, region 1170 can overlap with an upper portion of dielectric layer 128 adjacent to side surface 105r. In some embodiments, the upper portion of dielectric layer 126 and/or the upper portion of dielectric layer 128 can include the implanted dopants of the first type. In some embodiments, concentrations of dopants of the first type in the upper portion of dielectric layer 126 and the upper portion of dielectric layer 128 can be substantially the same.

In some embodiments, regions 970, 1070, and 1170 can be formed in a sequence different from the sequence described above. For example, the sequence can be (i) forming region 970, (ii) forming region 1170, and (iii) forming region 1070. In another example, the sequence can be (i) forming region 1170, (ii) forming region 1070, and (iii) forming region 970. Since regions 970, 1070, and 1170 are formed based on the same mask 850, regions 970, 1070, and 1170 can be less susceptible to inline process variations and can provide a robust junction profile in a subsequent thermal process. In some embodiments, boundaries between regions 970 and 1070 and between regions 1070 and 1170 can be substantially parallel with each other.

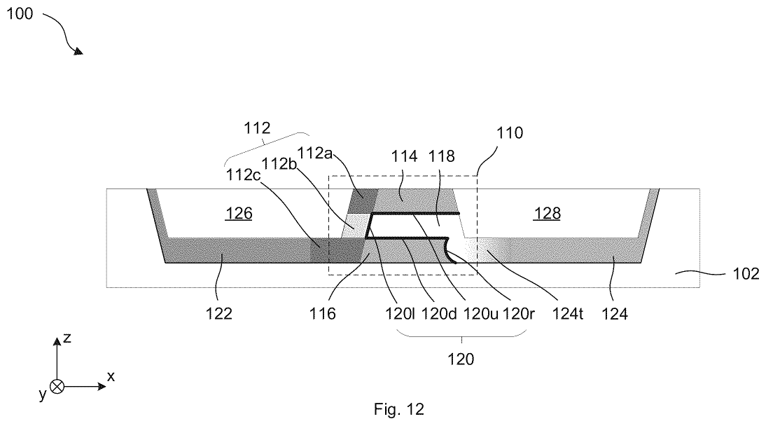

In referring to FIG. 2, method 200 continues with operation 240 and the process of performing a thermal process to activate the dopants, as described with reference to FIG. 12. FIG. 12 is a cross-sectional view of semiconductor device 100 after operation 240. In some embodiments, performing the thermal process can include annealing semiconductor device 100 under a temperature between about 900° C. and about 1100° C. for a period time between about 10 sec and about 100 min. In some embodiments, the thermal process can promote dopants in regions 970, 1070, and 1170 to reside in a crystal structure of optical waveguide 105 and form first, second, third, and fourth doped regions 112, 114, 116, and 118. In some embodiments, the thermal process can form the ‘C’ shape of P-N junction 120. In some embodiments, the formation of doped regions 112, 114, 116, and 118 and P-N junction 120 can define optical modulator 110 in optical waveguide 105. In some embodiments, the thermal process can facilitate the diffusions of dopants in doped regions 112, 114, 116, and 118, so that doping profiles in each of the doped regions are more uniform. In some embodiments, the thermal process can remove defects formed in optical waveguide 105 due to the ion implantation processes.

In some embodiments, the thermal process can also facilitate diffusions of dopants in pick-up regions 122 and 124. In particular, during the thermal process, second pick-up region 124 can extend towards optical modulator 110 due to the diffusion of dopants of the second type in second pick-up region 124 towards optical modulator 110. In some embodiments, an inter-diffusion between dopants of the second type in second pick-up region 124 and dopants of the first type in doped region 116 can form compensated region 124t. In some embodiments, during the thermal process, compensated region 124t can connect with third doped region 116 and fourth doped region 118. Since dopants in compensated region 124t and third doped region 116 are opposite types, interface 120r between compensated region 124t and third doped region 116 can form a P-N junction as a portion of P-N junction 120. Since dopants in compensated region 124t and fourth doped region 118 are the same type, compensated region 124t and fourth doped region 118 can be electrically connected without a P-N junction in between.

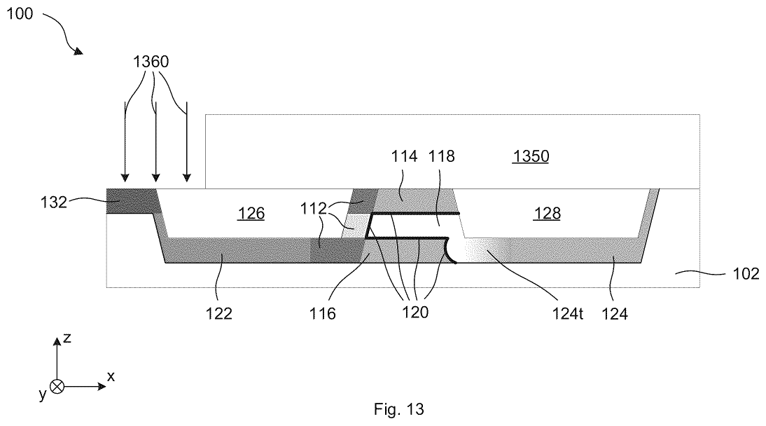

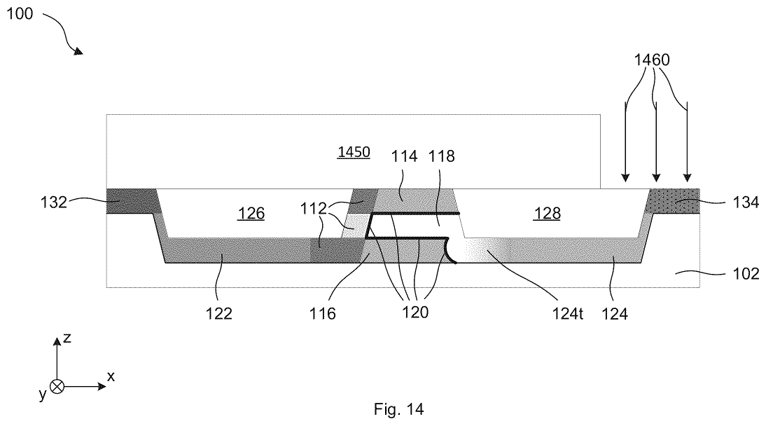

In referring to FIG. 2, method 200 continues with operation 245 and the process of forming first and second contact regions coupled to the pick-up regions, as described with reference to FIGS. 13 and 14. FIGS. 13 and 14 are cross-sectional views of semiconductor device 100 when forming first and second contact regions 132 and 134, respectively. In some embodiments, first contact region 132 can be formed prior to second contact region 134, or vice versa.

Referring to FIG. 13, in some embodiments, forming first contact region 132 can include (i) covering optical modulator 110 with a photoresist 1350 while exposing a portion of substrate 102 on the same side of optical modulator 110 as first pick-up region 122 and (ii) doping a region of the exposed substrate 102 by implanting dopants 1360 in an ion implantation process. In some embodiments, photoresist 1350 can also cover dielectric layer 128 and portions of substrate 102 on the same side of optical modulator 110 as dielectric layer 128. In some embodiments, photoresist 1350 can also cover a portion of dielectric layer 126 adjacent to optical modulator 110. In some embodiments, forming first contact region 132 can include electrically connecting first contact region 132 with first pick-up region 122 by choosing proper ion implantation parameters. In some embodiments, implanting dopants 1360 can include implanting dopants of the first type at an energy between about 5 keV and about 30 keV. In some embodiments, implanting dopants 1360 can include implanting dopants of the first type at a dose between about 1×10¹⁴ cm⁻² and about 3×10¹⁵ cm⁻². In some embodiments, implanting dopants 1360 can include implanting dopants of the first type at an angle between about 0° and about 30°. In some embodiments, forming first contact region 132 can further include removing photoresist 1350 after the formation of first contact region 132.

Referring to FIG. 14, in some embodiments, forming second contact region 134 can include (i) covering optical modulator 110 with a photoresist 1450 while exposing a portion of substrate 102 on the same side of optical modulator 110 as second pick-up region 124 and (ii) doping a region of the exposed substrate 102 by implanting dopants 1460 in an ion implantation process. In some embodiments, photoresist 1450 can also cover dielectric layer 126 and portions of substrate 102 on the same side of optical modulator 110 as dielectric layer 126. In some embodiments, photoresist 1450 can also cover a portion of dielectric layer 128 adjacent to optical modulator 110. In some embodiments, forming second contact region 134 can include electrically connecting second contact region 134 with second pick-up region 124 by choosing proper ion implantation parameters. In some embodiments, implanting dopants 1460 can include implanting dopants of the second type at an energy between about 5 keV and about 30 keV. In some embodiments, implanting dopants 1460 can include implanting dopants of the second type at a dose between about 1×10¹⁴ cm⁻² and about 3×10¹⁵ cm⁻². In some embodiments, implanting dopants 1460 can include implanting dopants of the second type at an angle between about 0° and about 30°. In some embodiments, forming second contact region 134 can further include removing photoresist 1450 after the formation of second contact region 134.

The embodiments described herein are directed to a semiconductor device including an optical modulator and a method of forming the semiconductor device. In some embodiments, the optical modulator includes a first doped region under a side surface of an optical waveguide, a second doped region under a top surface of the optical waveguide, a third doped region under the second doped region, and a fourth doped region between the second and third doped regions. In some embodiments, the first, second, and third doped regions include dopants of a first type, and the fourth doped region includes dopants of a second type opposite to the first type. In some embodiments, the first, second, third, and fourth doped regions form a P-N junction having a ‘C’ shape in the optical modulator. In some embodiments, the method of forming the semiconductor device includes applying a first mask to form the first doped region by implanting dopants of the first type under the side surface of the optical waveguide. In some embodiments, the method further includes applying a second mask to form the second, third, and fourth doped regions by implanting dopants of the first and second types under the top surface of the optical waveguide. In some embodiments, the P-N junction formed by the method is self-aligned and immune to variations of the first and second masks, providing a reliable and consistent product yield.

In some embodiments, a method includes forming a ridge on a substrate, forming an n-type region under a first side surface of the ridge, and forming a mask on the substrate. The mask exposes a top surface of the ridge. An opening of the mask is above the first side surface and a second side surface of the ridge. The method further includes doping the ridge with a first n-type dopant, a second n-type dopant, and a p-type dopant based on the mask. A first implantation energy of the first n-type dopant is less than a second implantation energy of the second n-type dopant. A third implantation energy of the p-type dopant is less than the second implantation energy.

In some embodiments, a method includes forming an optical waveguide on a substrate and forming an optical modulator in the optical waveguide. Forming the optical modulator includes forming a first n-type layer under a side surface of the optical waveguide, forming a mask on the substrate and exposing the optical waveguide, and performing first, second, and third implantation operations based on the mask. The first implantation operation forms a second n-type layer in the optical waveguide. The second implantation operation forms a third n-type layer in the optical waveguide and on the second n-type layer. The third implantation operation forms a p-type layer on the second n-type layer and under the third n-type layer.

In some embodiments, a structure includes a ridge on a substrate and a P-N junction in the ridge. The P-N junction includes a first n-type region in the substrate, a p-type region on the first n-type doped region, a second n-type region on the p-type region, and a third n-type region connecting the first and second n-type regions. A first interface between the p-type region and the first n-type region and a second interface between the p-type region and the second n-type region are substantially parallel. The structure further includes an n-type contact region and a p-type contact region in the substrate. The n-type contact region is coupled to the third n-type region. The p-type contact region is coupled to the p-type region.

It is to be appreciated that the Detailed Description section, and not the Abstract of the Disclosure section, is intended to be used to interpret the claims. The Abstract of the Disclosure section may set forth one or more but not all possible embodiments of the present disclosure as contemplated by the inventor(s), and thus, are not intended to limit the subjoined claims in any way.

The foregoing disclosure outlines features of several embodiments so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the embodiments introduced herein. Those skilled in the art will also realize that such equivalent constructions do not depart from the spirit and scope of the present disclosure, and that they may make various changes, substitutions, and alterations herein without departing from the spirit and scope of the present disclosure.

1. A method, comprising:
forming a ridge on a substrate;
forming an n-type region under a first side surface of the ridge;
forming a mask on the substrate, wherein the mask exposes a top surface of the ridge, and wherein an opening of the mask is above the first side surface and a second side surface of the ridge; and
doping, based on the mask, the ridge with a first n-type dopant, a second n-type dopant, and a p-type dopant, wherein:
a first implantation energy of the first n-type dopant is less than a second implantation energy of the second n-type dopant; and
a third implantation energy of the p-type dopant is less than the second implantation energy.

2. The method of claim 1, further comprising forming a dielectric layer on the substrate and having a top surface coplanar with the top surface of the ridge.

3. The method of claim 2, wherein forming the mask comprises exposing a portion of the dielectric layer adjacent to the ridge.

4. The method of claim 1, wherein forming the n-type region comprises implanting a third n-type dopant at an angle between about 0° and about 45° with respect to a direction perpendicular to the substrate.

5. The method of claim 1, wherein forming the n-type region comprises implanting a third n-type dopant, wherein:
a dose of the third n-type dopant is between about 1×10¹⁴ cm⁻² and about 6×10¹⁴ cm⁻²; and
an implantation energy of the third n-type dopant is between about 40 keV and about 80 keV.

6. The method of claim 1, wherein doping the ridge comprises implanting the first n-type dopant, the second n-type dopant, and the p-type dopant at a direction substantially perpendicular to the substrate.

7. The method of claim 1, wherein:
the first implantation energy is between about 20 keV and about 50 keV;
the second implantation energy is between about 20 keV and about 60 keV; and
the third implantation energy is between about 100 keV and about 200 keV.

8. The method of claim 1, wherein:
a first dose of the first n-type dopant is between about 5×10¹³ cm⁻² and about 5×10¹⁴ cm⁻²;
a second dose of second n-type dopant is between about 5×10¹³ cm⁻² and about 5×10¹⁴ cm⁻²; and
a third dose of the p-type dopant is between about 5×10¹³ cm⁻² and about 5×10¹⁴ cm⁻².

9. A method, comprising:
forming an optical waveguide on a substrate; and
forming an optical modulator in the optical waveguide, comprising:
forming a first n-type region under a side surface of the optical waveguide;
forming a mask on the substrate and exposing the optical waveguide;
performing a first implantation operation based on the mask, wherein the first implantation operation forms a second n-type region in the optical waveguide;
performing a second implantation operation based on the mask, wherein the second implantation operation forms a third n-type region in the optical waveguide and on the second n-type region; and
performing a third implantation operation based on the mask, wherein the third implantation operation forms a p-type region on the second n-type region and under the third n-type region.

10. The method of claim 9, wherein performing the first implantation operation comprises implanting n-type dopants having an energy greater than energies of dopants implanted during the second and third implantation operations.

11. The method of claim 9, wherein:
performing the first implantation operation comprises implanting phosphorus at a first dose between about 5×10¹³ cm⁻² and about 5×10¹⁴ cm⁻²;
performing the second implantation operation comprises implanting phosphorus at a second dose between about 5×10¹³ cm⁻² and about 5×10¹⁴ cm⁻²; and
performing the third implantation operation comprises implanting boron at a third dose between about 5×10¹³ cm⁻² and about 5×10¹⁴ cm⁻².

12. The method of claim 9, wherein performing the first, second, and third implantation operations comprise implanting dopants at a direction substantially perpendicular to the substrate.

13. The method of claim 9, wherein forming the mask comprises forming an opening exposing the optical waveguide, and wherein a width of the opening is greater than a width of the optical waveguide.

14. The method of claim 9, further comprising:
forming a first contact region in the substrate and coupled to the first, second, and third n-type regions; and
forming a second contact region in the substrate and coupled to the p-type region.

15. A structure, comprising:
a ridge on a substrate;
a P-N junction in the ridge, wherein the P-N junction comprises:
a first n-type region in the substrate;
a p-type region on the first n-type region;
a second n-type region on the p-type region; and
a third n-type region connecting the first and second n-type regions, wherein the third n-type region comprises p-type dopants having a substantially same concentration as p-type dopants in the p-type region;
an n-type contact region in the substrate and coupled to the third n-type region; and
a p-type contact region in the substrate and coupled to the p-type region.

16. The structure of claim 15, wherein the P-N junction has a C-shape.

17. The structure of claim 15, wherein:
the p-type region comprises boron; and
the first and second n-type regions comprise phosphorus.

18. The structure of claim 15, wherein the third n-type region comprises phosphorus and arsenic.

19. The structure of claim 15, wherein:
the third n-type region comprises a first portion adjacent to the first n-type region and a second portion adjacent to the p-type region; and
a concentration of n-type dopants in the first portion is greater than a concentration of n-type dopants in the second portion.

20. The structure of claim 19, wherein a concentration of the p-type dopants in the second portion is less than the concentration of the n-type dopants in the second portion.
